(19) United States
(12) Patent Application Publication
(10) Pub. No.: US 2024/0034393 A1
(43) Pub. Date: Feb. 1, 2024

(54) RACK ELECTRIC POWER STEERING DUAL BALL NUT ASSEMBLY

(71) Applicant: Steering Solutions IP Holding Corporation, Saginaw, MI (US)

(72) Inventors: Christopher R. Case Myers, Freeland, MI (US); Travis L. Palmer, Frankenmuth, MI (US); Eric D. Pattok, Frankenmuth, MI (US)

(21) Appl. No.: 18/360,449

(22) Filed: Jul. 27, 2023

Related U.S. Application Data
(60) Provisional application No. 63/392,931, filed on Jul. 28, 2022.

(51) Int. Cl. B62D 5/04; F16H 25/22

(52) U.S. Cl. CPC B62D 5/0448; B62D 5/0424; F16H 25/2214; F16H 2025/2081

(57) ABSTRACT

A ball nut assembly for a rack electric power steering system in a vehicle includes a ball screw at least partially disposed within a rack housing. The ball nut assembly also includes a first ball nut disposed about the ball screw. The ball nut assembly further includes a second ball nut disposed about the ball screw, wherein the first ball nut and the second ball nut are disposed within the rack housing.

### CROSS-REFERENCE TO RELATED APPLICATION

This application claims the benefits of priority to U.S. Provisional Patent Application Ser. No. 63/392,931, filed Jul. 28, 2022, the entire disclosure of which is incorporated by reference herein in its entirety.

### BACKGROUND

Vehicle power assist systems such as an electric power steering system may include an actuator having a synchronous belt that transmits a torque from the electric motor to a component. The actuator assists in applying a torque or load to the component to perform a vehicle function, such as turning or steering.

In current rack electric power steering systems (REPS), a single ball nut is all that is required to transmit load from an assist mechanism to a ball screw. In a higher loaded system, there is a point where the size of the ball nut needs to be increased for load capacity. Alternatively, assemblies must be added to the same ball screw for higher capacity.

### SUMMARY

According to one aspect of the disclosure, a steering assist system with a road wheel actuator assembly includes a ball screw extending along a first axis. The steering assist system also includes a pulley assembly. The steering assist system further includes a ball nut assembly driven by the pulley assembly. The ball nut assembly includes a first ball nut that is disposed about the ball screw. The ball nut assembly also includes a second ball nut that is disposed about the ball screw, wherein the first ball nut and the second ball nut are disposed within the same housing. The ball nut assembly further includes an axial spacer disposed between the first ball nut and the second ball nut.

According to another aspect of the disclosure, a ball nut assembly for a rack electric power steering system in a vehicle includes a ball screw at least partially disposed within a rack housing. The ball nut assembly also includes a first ball nut disposed about the ball screw. The ball nut assembly further includes a second ball nut disposed about the ball screw, wherein the first ball nut and the second ball nut are disposed within the rack housing.

According to yet another aspect of the disclosure, a steering assist system with a road wheel actuator assembly includes a ball screw extending along a first axis. The steering assist system also includes a pulley assembly. The pulley assembly includes a first drive pulley operatively coupled to a motor pulley shaft and connected to a first driven pulley. The pulley assembly also includes a second drive pulley operatively coupled to a motor pulley shaft and connected to a second driven pulley. The steering assist system also includes a ball nut assembly. The ball nut assembly includes a first ball nut that is disposed about the ball screw and driven by the first driven pulley. The ball nut assembly also includes a second ball nut that is disposed about the ball screw and driven by the second driven pulley, wherein the first ball nut and the second ball nut are disposed within the same housing. The ball nut assembly further includes an axial spacer disposed between the first ball nut and the second ball nut. The ball nut assembly yet further includes a first bearing operatively coupled to the first ball nut. The ball nut assembly also includes a second bearing operatively coupled to the second ball nut, wherein the axial spacer is disposed between the first bearing and the second bearing.

These and other advantages and features will become more apparent from the following description taken in conjunction with the drawings.

### BRIEF DESCRIPTION OF THE DRAWINGS

The subject matter of the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a perspective view of a steering assist system with a road wheel actuator assembly according to the prior art;

FIG. 2 is a cross-sectional view of a road wheel actuator assembly according to one aspect of the disclosure; and

FIG. 3 is a cross-sectional view of the road wheel actuator assembly according to another aspect of the disclosure.

### DETAILED DESCRIPTION

Referring now to the Figures, where the present disclosure will be described with reference to specific embodiments, without limiting same, it is to be understood that the disclosed embodiments are merely illustrative of the present disclosure that may be embodied in various and alternative forms. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

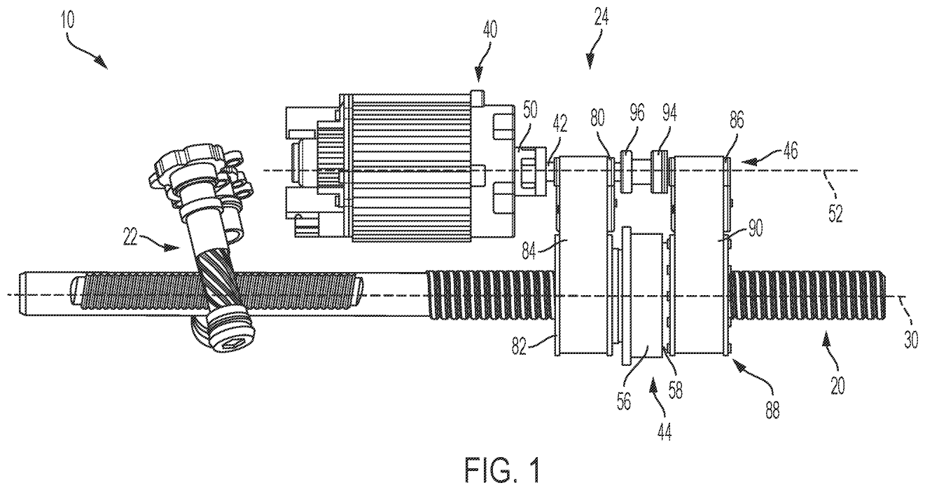

Vehicles may be provided with a steering assist system that pivots or turns a vehicle wheel or road wheel responsive to a steering input provided by an operator of the vehicle or in response to a command from an autonomous or semi-autonomous steering system. Referring to FIG. 1, the steering assist system includes a road wheel actuator assembly 10 that is arranged to pivot the vehicle wheel or vehicle road wheel. The road wheel actuator assembly 10 includes a rack bar 20, a pinion gear 22, and a power steering assist mechanism 24. While the embodiments disclosed herein may be used with actuator assemblies having a pinion gear 22, it is to be understood that the disclosed embodiments may be used with other driving components which provide anti-rotation.

The rack bar 20 extends along a first axis 30 and has ends that are operatively connected to tie rods that aid in pivoting, steering, or turning, a vehicle road wheel. The rack bar 20 is configured as a ball screw having threads, teeth, or the like that engage with the pinion gear 22. The pinion gear 22 is operatively connected to an input shaft—or driver input—and rotates responsive to a steering input provided by an operator of the vehicle. The rotation of the pinion gear 22, while meshingly engaged with the rack bar 20, causes the rack bar 20 to translate along the first axis 30 to pivot a vehicle road wheel.

The power steering assist mechanism 24 is operatively connected to the rack bar 20 and provides an assist torque that is translated into an axial force that is used to aid in translating the rack bar 20 to pivot the vehicle road wheels. The power steering assist mechanism 24 includes a motor 40, a drive pulley shaft 42, a ball nut assembly 44, and a pulley assembly 46. The motor 40 may be an electric motor, hydraulic actuator, an electrohydraulic motor, or the like that is operatively connected to the drive pulley shaft 42. The drive pulley shaft 42 is connected to the motor 40 by a compliant motor coupling 50 or may be integrally formed with the motor output shaft. The drive pulley shaft 42 extends along a second axis 52 that is disposed substantially parallel to the first axis 30. The drive pulley shaft 42 is free to rotate about the second axis 52 through bearings 94, 96.

The ball nut assembly 44 is disposed about the rack bar 20. The ball nut assembly 44 includes a single ball nut 58 which is rotated based on operation of the pulley assembly 46. In particular, a first drive pulley 80 is rotated by the drive pulley shaft 42. Similarly, a second drive pulley 86 is rotated by the drive pulley shaft 42. Each drive pulley 80, 86 moves a pulley belt 84, 90 to rotate a respective driven pulley 82, 88. The driven pulleys are operatively in contact with the single ball nut 58 to rotate the ball nut 58. The ball nut 58 is axially fixed relative to the rack bar 20, but is in threaded contact with the rack bar 20 to axially translate the rack bar 20 to provide the assist force desired. In some embodiments, a single bearing may be utilized. In such embodiments, the single bearing is located axially outboard of the second drive pulley 86.

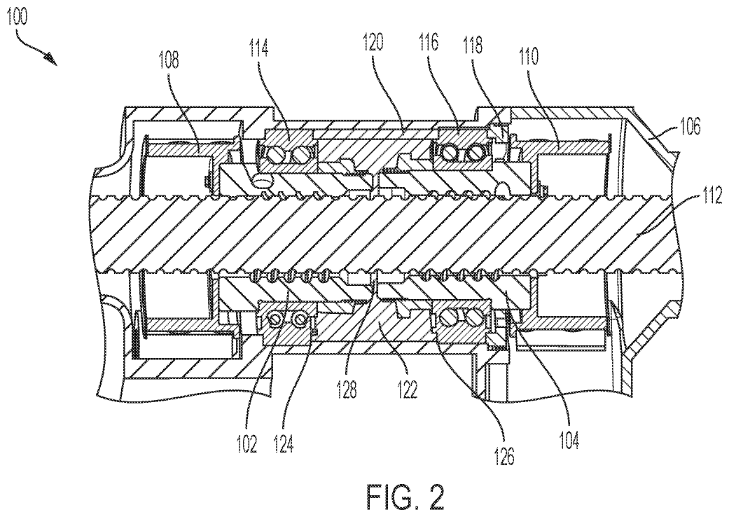

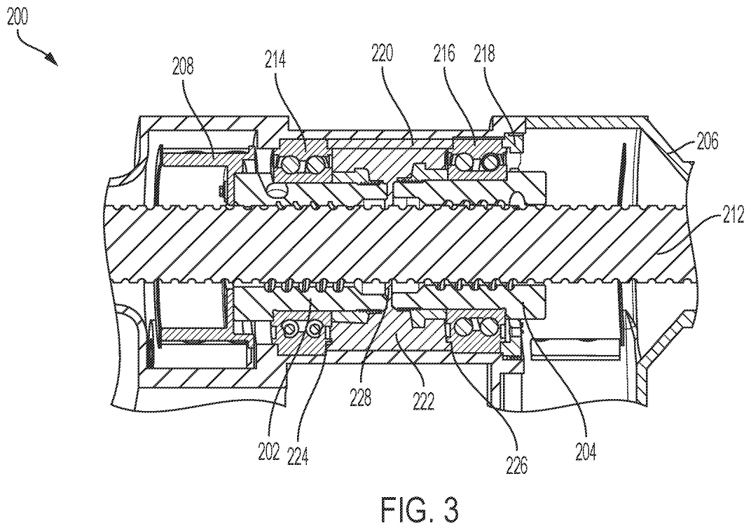

Referring to FIG. 2, a ball nut assembly is shown according to the embodiments disclosed herein and is generally referenced with numeral 100. The ball nut assembly 100 includes a plurality of ball nuts instead of a single ball nut. In particular, the ball nut assembly 100 includes a first ball nut 102 and a second ball nut 104. The ball nuts are driven by a drive pulley assembly which may be similar to the drive pulley assembly shown in FIG. 1 and described in detail above. Therefore, operation of the motor 40 and drive pulley(s) is not duplicated in connection with the embodiments of FIGS. 2 and 3. However, the dual nut assembly disclosed herein provides a larger load carrying capacity, when compared to a single nut assembly, while still being disposed within a single housing 106.

In the embodiment of FIG. 2, a first driven pulley 108 is operatively coupled to the first ball nut 102 to cause rotation of the first ball nut 102. Similarly, a second driven pulley 110 is operatively coupled to the second ball nut 104 to cause rotation of the second ball nut 104. The inner surface of each ball nut 102, 104 meshes with the ball screw 112 through a set of recirculating balls that aid in converting torque applied by the pulley assembly—and directly from the driven pulleys 108, 110—into an axial force that aids in turning a vehicle road wheel.

Each ball nut has a respective bearing associated therewith which is operatively connected to the respective ball nut. In particular, the first ball nut 102 is operatively connected to a first bearing 114, while the second ball nut 104 is operatively connected to a second bearing 116. The bearings 114, 116 are bounded at a radially outward location of each by an inner surface of the housing 106 or an intermediate component. The first bearing 114 is axially retained on an axially outward side by a shoulder protruding radially inwardly from the inner surface of the housing 106. The second bearing 116 is axially retained on an axially outward side by a retaining nut 118 which is coupled to the housing 106 to provide an axially stacked configuration of bearings 114, 116, along with an axial spacer 120 which is described in detail below.

The ball nuts 102, 104 and the bearings 114, 116 are each separated by the axial spacer 120 disposed within the housing 106. In particular, the axial spacer 120 has a main body portion 122 which extends axially from a first end 124 to a second end 126 and circumferentially at least partially around the interior of the housing 106. In some embodiments, the main body portion 122 extends circumferentially completely around the interior of the housing 106 (i.e., 360 degrees), while some embodiments include only partial circumferential extension. The first end 124 of the main body portion 122 abuts an axially inward end of the first bearing 114. The second end 126 of the main body portion 122 abuts an axially inward end of the second bearing 116. The positioning and contact between the main body portion 122 of the axial spacer 120 and the bearings 114, 116 axially space the bearings 114, 116 from each other. The axial spacer 120 also includes a radially inwardly protrusion 128 which extends radially inwardly from the main body portion 122 and is positioned between axially inner ends of the first ball nut 102 and the second ball nut 104 to axially space the ball nuts 102, 104. It is contemplated that axial spacing of the ball nuts 102, 104 may be achieved with another component, such as a coupler, spine, tooth or pin provided between the ball nuts 102, 104. The preceding list are merely examples of the components which may be used to axially space the ball nuts 102, 104.

Referring now to FIG. 3, the ball nut assembly is shown according to another disclosed embodiment and is generally referenced with numeral 200. The ball nut assembly 200 is identical to the ball nut assembly 100 of FIG. 2, but includes a single driven pulley rather than the dual pulley assembly disclosed in connection with FIG. 2. The embodiment of FIG. 3 is described in detail below.

The ball nut assembly 200 includes a plurality of ball nuts instead of a single ball nut, as present in prior art rack assist ball nut assemblies. In particular, the ball nut assembly 200 includes a first ball nut 202 and a second ball nut 204. The ball nuts are driven by a drive pulley assembly. However, the dual nut assembly disclosed herein provides a larger load carrying capacity, when compared to a single nut assembly, while still being disposed within a single housing 206.

In the embodiment of FIG. 3, a single, common driven pulley 208 is operatively coupled to the first ball nut 202 to cause rotation of the first ball nut 202. As discussed above, axial spacing of the ball nuts 102, 104 may be achieved with another component, such as a coupler, spine, tooth or pin (or an alternative) provided between the ball nuts 102, 104. In such embodiments, such components would be integrated into the ball nuts 102, 104 to couple the components and facilitate rotation of the ball nuts 102, 104 with the single, common pulley 208.

The inner surface of each ball nut 202, 204 meshes with the ball screw 212 through a set of recirculating balls that aid in converting torque applied by the pulley assembly—and directly from the driven pulley 208—into an axial force that aids in turning a vehicle road wheel.

Each ball nut has a respective bearing associated therewith which is operatively connected to the respective ball nut. In particular, the first ball nut 202 is operatively connected to a first bearing 214, while the second ball nut 204 is operatively connected to a second bearing 216. The bearings 214, 216 are bounded at a radially outward location of each by an inner surface of the housing 206 or an intermediate component. The first bearing 214 is axially retained on an axially outward side by a shoulder protruding radially inwardly from the inner surface of the housing 206. The second bearing 216 is axially retained on an axially outward side by a retaining nut 218 which is coupled to the housing 206 to provide an axially stacked configuration of bearings 214, 216, along with an axial spacer 220 which is described in detail below.

The ball nuts 202, 204 and the bearings 214, 216 are each separated by the axial spacer 220 disposed within the housing 206. In particular, the axial spacer 220 has a main body portion 222 which extends axially from a first end 224 to a second end 226 and circumferentially at least partially around the interior of the housing 206. In some embodiments, the main body portion 222 extends circumferentially completely around the interior of the housing 206 (i.e., 360 degrees), while some embodiments include only partial circumferential extension. The first end 224 of the main body portion 222 abuts an axially inward end of the first bearing 214. The second end 226 of the main body portion 222 abuts an axially inward end of the second bearing 216. The positioning and contact between the main body portion 222 of the axial spacer 220 and the bearings 214, 216 axially space the bearings 214, 216 from each other. The axial spacer 220 also includes a radially inwardly protrusion 228 which extends radially inwardly from the main body portion 222 and is positioned between axially inner ends of the first ball nut 202 and the second ball nut 204 to axially space the ball nuts 202, 204.

The embodiments disclosed herein utilize two ball nuts on the same ball screw to carry double the load of a single ball nut assembly. In the disclosed assemblies 100, 200, the direction of one of the ball nuts is reversed and an axial spacer has been added. This facilitates doubling the load capacity without developing a larger design for the current components. This configuration also still allows the overall assembly to be installed into the same housing from the same direction instead of splitting the mechanization up into multiple housings or having to assemble the ball nuts at different times into the final assembly.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the scope of the present disclosure. Additionally, while various embodiments of the present disclosure have been described, it is to be understood that aspects of the present disclosure may include only some of the described embodiments or combinations of the various embodiments. Accordingly, the present disclosure is not to be seen as limited by the foregoing description.

What is claimed is:

1. A steering assist system with a road wheel actuator assembly, comprising:
a ball screw extending along a first axis;
a pulley assembly; and
a ball nut assembly driven by the pulley assembly, the ball nut assembly comprising:
a first ball nut that is disposed about the ball screw;
a second ball nut that is disposed about the ball screw, wherein the first ball nut and the second ball nut are disposed within the same housing; and
an axial spacer disposed between the first ball nut and the second ball nut.

2. The steering assist system of claim 1, wherein the axial spacer comprises:
a main body portion extending circumferentially around at least a portion of an inner surface of the housing; and
a protrusion extending radially inwardly from the main body portion and disposed between an axially inward end of the first ball nut and an axially inward end of the second ball nut.

3. The steering assist system of claim 1, further comprising:
a first bearing operatively coupled to the first ball nut; and
a second bearing operatively coupled to the second ball nut, wherein the axial spacer is disposed between the first bearing and the second bearing.

4. The steering assist system of claim 3, wherein the axial spacer includes a main body portion extending from a first axial end to a second axial end, wherein the first axial end is in abutment with an axially inward end of the first bearing, wherein the second axial end is in abutment with an axially inward end of the second bearing.

5. The steering assist system of claim 3, further comprising a shoulder extending radially inwardly from an inner surface of the housing, the shoulder in abutment with a radially outward end of the first bearing to axially retain the first bearing.

6. The steering assist system of claim 3, further comprising a retaining nut operatively coupled to the housing and in abutment with a radially outward end of the second bearing to axially retain the second bearing.

7. A ball nut assembly for a rack electric power steering system in a vehicle, the ball nut assembly comprising:
a ball screw at least partially disposed within a rack housing;
a first ball nut disposed about the ball screw; and
a second ball nut disposed about the ball screw, wherein the first ball nut and the second ball nut are disposed within the rack housing.

8. The ball nut assembly of claim 7, further comprising an axial spacer disposed between the first ball nut and the second ball nut.

9. The ball nut assembly of claim 8, wherein the axial spacer comprises:
a main body portion extending circumferentially around at least a portion of an inner surface of the rack housing; and
a protrusion extending radially inwardly from the main body portion and disposed between an axially inward end of the first ball nut and an axially inward end of the second ball nut.

10. The ball nut assembly of claim 8, further comprising:
a first bearing operatively coupled to the first ball nut; and
a second bearing operatively coupled to the second ball nut, wherein the axial spacer is disposed between the first bearing and the second bearing.

11. The ball nut assembly of claim 10, wherein the axial spacer includes a main body portion extending from a first axial end to a second axial end, wherein the first axial end is in abutment with an axially inward end of the first bearing, wherein the second axial end is in abutment with an axially inward end of the second bearing.

12. The ball nut assembly of claim 10, further comprising a shoulder extending radially inwardly from an inner surface of the rack housing, the shoulder in abutment with a radially outward end of the first bearing to axially retain the first bearing.

13. The ball nut assembly of claim 10, further comprising a retaining nut operatively coupled to the rack housing and in abutment with a radially outward end of the second bearing to axially retain the second bearing.

14. The ball nut assembly of claim 7, further comprising a single, common driven pulley operatively coupled to the first ball nut or the second ball nut, wherein the first ball nut and the second ball nut are operatively coupled to each other to commonly rotate, wherein the single, common driven pulley actuates rotation of both the first ball nut and the second ball nut.

15. The ball nut assembly of claim 14, wherein the first ball nut and the second ball nut are operatively coupled to each other with one of a coupler, a spine, a tooth and a pin.

16. A steering assist system with a road wheel actuator assembly, comprising:
a ball screw extending along a first axis;
a pulley assembly comprising:
a first drive pulley operatively coupled to a motor pulley shaft and connected to a first driven pulley; and
a second drive pulley operatively coupled to a motor pulley shaft and connected to a second driven pulley;
a ball nut assembly comprising:
a first ball nut that is disposed about the ball screw and driven by the first driven pulley; and
a second ball nut that is disposed about the ball screw and driven by the second driven pulley, wherein the first ball nut and the second ball nut are disposed within the same housing;
an axial spacer disposed between the first ball nut and the second ball nut;
a first bearing operatively coupled to the first ball nut; and
a second bearing operatively coupled to the second ball nut, wherein the axial spacer is disposed between the first bearing and the second bearing.

17. The steering assist system of claim 16, wherein the axial spacer comprises:
a main body portion extending circumferentially around at least a portion of an inner surface of the housing; and
a protrusion extending radially inwardly from the main body portion and disposed between an axially inward end of the first ball nut and an axially inward end of the second ball nut.

18. The steering assist system of claim 17, wherein the main body portion of the axial spacer extends from a first axial end to a second axial end, wherein the first axial end is in abutment with an axially inward end of the first bearing, wherein the second axial end is in abutment with an axially inward end of the second bearing.

19. The steering assist system of claim 18, further comprising a shoulder extending radially inwardly from the inner surface of the housing, the shoulder in abutment with a radially outward end of the first bearing to axially retain the first bearing.

20. The steering assist system of claim 19, further comprising a retaining nut operatively coupled to the housing and in abutment with a radially outward end of the second bearing to axially retain the second bearing.
